(19) United States
(12) Patent Application Publication
(10) Pub. No.: US 2022/0403879 A1
(43) Pub. Date: Dec. 22, 2022

(54) RESIN MATERIAL FOR SLIDING MEMBER AND SLIDING MEMBER

(71) Applicant: TAIHO KOGYO CO., LTD., Toyota-shi, Aichi (JP)

(72) Inventors: Hiroaki KOBAYASHI, Aichi (JP); Naoki HORIBE, Aichi (JP); Toshiyuki CHITOSE, Aichi (JP)

(73) Assignee: TAIHO KOGYO CO., LTD., Toyota-shi, Aichi (JP)

(21) Appl. No.: 17/772,204

(22) PCT Filed: Jul. 28, 2020
(86) PCT No.: PCT/JP2020/028935

§ 371 Date: Apr. 27, 2022

(30) Foreign Application Priority Data
Nov. 27, 2019 (JP) 2019-214708

(51) Int. Cl. F16C 33/20; F16C 17/02

(52) U.S. Cl. CPC F16C 33/201; F16C 17/02; F16C 2208/32; F16C 2206/02; F16C 2208/40; F16C 2202/52; F16C 2208/82

(57) ABSTRACT

A resin material 16 for a sliding member contains a synthetic resin 18, graphite particles 20 dispersed in the synthetic resin 18, and a hard material 24. The synthetic resin 18 contains 5% or more by volume and 30% or less by volume of polytetrafluoroethylene (PTFE) 22. The graphite particles 20 have an average particle diameter of 0.5 μm or more and 5.0 μm or less and have a content of 1% or more by volume and 15% or less by volume in the synthetic resin 18.

### FIELD

The present invention relates to a resin material for a sliding member and a sliding member.

### BACKGROUND

Resin materials in which graphite is added to binder resin have conventionally been known as resin materials for use in a resin layer of sliding members.

A resin material in which 9.5% or more by volume and 20% or less by volume of graphite is dispersed in a polyimide resin is disclosed, for example. Further, a technique dispersing 5% or more by volume and 50% or less by volume of graphite particles in a resin layer, in which spheroidal graphite particles and scaly graphite particles are mixed together as the graphite particles, is disclosed.

### CITATION LIST

### Patent Literature

Patent Document 1: Japanese Patent Application Laid-open No. 2018-193521

Patent Document 2: Japanese Patent Application Laid-open No. 2018-71581

### SUMMARY

### Technical Problem

However, it has been difficult for the conventional technologies to achieve both dry seizing resistance and seizing resistance in oil.

An object of the present invention is to provide a resin material for a sliding member and a sliding member that can achieve both improvement in dry seizing resistance and seizing resistance in oil.

### Solution to Problem

In order to solve the above problem and achieve the object, a resin material for a sliding member according to the present invention includes a synthetic resin, graphite particles dispersed in the synthetic resin, and a hard material, the synthetic resin containing 5% or more by volume and 30% or less by volume of polytetrafluoroethylene (PTFE), the graphite particles having an average particle diameter of 0.5 μm or more and 5.0 μm or less and having a content of 1% or more by volume and 15% or less by volume in the synthetic resin

### Advantageous Effects of Invention

The present invention can achieve both improvement in dry seizing resistance and improvement in seizing resistance in oil.

### BRIEF DESCRIPTION OF DRAWINGS

FIG. 1 is a schematic diagram of an example of a sliding member of an embodiment.

FIG. 2 is a schematic diagram of an example of the sliding member of the embodiment.

FIG. 3 is a schematic diagram of an example of an application of the sliding member.

### DESCRIPTION OF EMBODIMENTS

The following describes an embodiment of a resin material for a sliding member and a sliding member according to the present invention in detail with reference to the accompanying drawings.

The resin material for a sliding member of the present embodiment contains a synthetic resin, graphite particles dispersed in the synthetic resin, and a hard material. The synthetic resin contains 5% or more by volume and 30% or less by volume of polytetrafluoroethylene (PTFE), and the graphite particles have an average particle diameter of 0.5 μm or more and 5.0 μm or less and have a volume corresponding to 1% or more by volume and 15% or less by volume in the synthetic resin.

A resin layer formed of the resin material for a sliding member of the present embodiment contains PTFE with the content and the graphite particles with the content and the average particle diameter and can thereby improve both seizing resistance in a dry environment and seizing resistance in an oil environment.

Although the reason for the above effect to be produced is not clear, it is presumed as follows. However, the invention is not limited by the following presumption.

It is presumed that containing PTFE with the content can reduce the friction coefficient of the resin layer formed of the resin material for a sliding member. It is also presumed that containing the graphite particles with the content and the average particle diameter improves the lipophilicity of the resin layer formed of the resin material for a sliding member. It is also presumed that containing PTFE with the content and the graphite particles with the content and the average particle diameter can achieve both a reduction in the friction coefficient of the resin layer and improvement in the lipophilicity of the resin layer. Thus, it is presumed that the resin layer formed of the resin material for a sliding member of the present embodiment can achieve both improvement in dry seizing resistance and improvement in seizing resistance in oil.

Dry seizing resistance means the seizing resistance of the surface of the resin layer in a dry environment, in which no lubricant such as oil is present between the resin layer and any member that can come into contact with the surface of the resin layer. Seizing resistance in oil means the seizing resistance of the surface of the resin layer in an oil environment, in which a lubricant such as oil is present between the resin layer and any member that can come into contact with the surface of the resin layer.

The following describes the resin material for a sliding member and a sliding member of the present embodiment in detail.

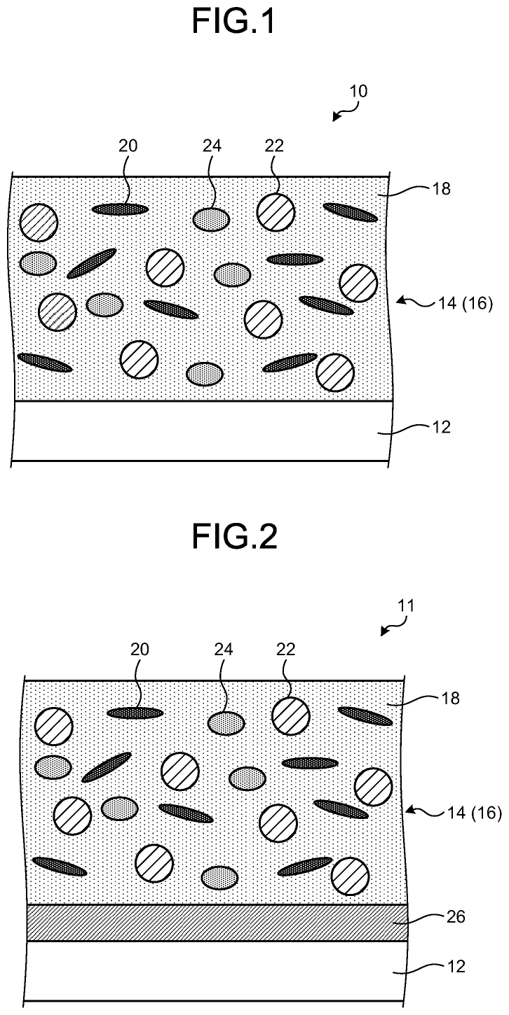

FIG. 1 is a schematic diagram of an example of a sliding member 10 of the present embodiment. FIG. 1 schematically illustrates an example of a sectional structure of the sliding member 10.

The sliding member 10 includes a base 12 and a resin layer 14. The sliding member 10 is a laminate of the base 12 and the resin layer 14 formed on the base 12.

The base 12 is a layer for providing the sliding member 10 with mechanical strength. The base 12 may be referred to as backing metal or a backing metal layer. For the base 12, a metal sheet formed of an Fe alloy, Cu, or a Cu alloy can be used, for example.

The resin layer 14 is a layer formed of a resin material 16 for a sliding member. The resin material 16 for a sliding member contains a synthetic resin 18 and additives dispersed in the synthetic resin 18.

The synthetic resin 18 contains 5% or more by volume and 30% or less by volume of polytetrafluoroethylene (PTFE). In the present embodiment, PTFE 22, which is PTFE in particle form, is dispersed in the synthetic resin 18.

The content of the PTFE 22 in the synthetic resin 18 corresponds to 5% or more by volume and 30% or less by volume, which is preferably 10% or more by volume and 25% or less by volume, and more preferably 12% or more by volume and 20% or less by volume.

When the content of the PTFE 22 in the synthetic resin 18 is within the above range, the friction coefficient of the resin layer 14 formed of the resin material 16 for a sliding member can be reduced. In addition, the PTFE 22 has high heat resistance and is difficult to dissolve and decompose. Thus, containing the PTFE 22 in the synthetic resin 18 can effectively reduce the friction coefficient of the resin layer 14, and dry seizing resistance can be improved.

In addition, the PTFE 22 contributes to a reduction in seizing resistance in oil. Thus, the content of the PTFE 22 is set to be within the above range, whereby the seizing resistance in oil of the resin layer 14 can be inhibited from being hindered.

The average particle diameter of the PTFE 22 is not limited. The average particle diameter of the PTFE 22 is, for example, preferably 1 μm or more and 25 μm or less, more preferably 1 μm or more and 15 μm or less, and especially preferably 2 μm or more and 8 μm or less.

When the average particle diameter of the PTFE 22 is within the above range, the total area of the surface area of the PTFE 22 dispersed in the synthetic resin 18 increases. Thus, even if the content of the PTFE 22 is a smaller content within the above range, the dry seizing resistance of the resin layer 14 can effectively be improved.

The average particle diameter of the PTFE 22 refers to an average primary particle diameter of the PTFE 22. The average primary particle diameter refers to a cumulative 50% particle diameter of a volume average particle diameter. A scanning electron microscope (SEM) can be used to measure the average particle diameter of the PTFE 22. The particles of the PTFE 22 are observed by SEM observation at an appropriate magnification (e.g., about 5,000-power), the diameter of each of 100 primary particles is measured to calculate their volume, and the cumulative 50% particle diameter can be regarded as the average primary particle diameter. If a particle of the PTFE 22 is not spherical, the average of a long diameter and a short diameter is regarded as the diameter of the primary particle.

The shape of the PTFE 22 is not limited. The shape of the PTFE 22 may be either spherical or spheroidal, for example. The method for producing the PTFE 22 is not limited. For the PTFE 22, any of PTFE particles produced by suspension polymerization, PTFE particles produced by emulsion polymerization, and recycled PTFE particles may be used, for example.

The synthetic resin 18 may further contain one or two or more selected from polyimide (PI), polyamide imide (PAI), polybenzimidazole (PBI), polyamide (PA), phenol, epoxy, polyacetal (POM), polyetheretherketone (PEEK), polyethylene (PE), polyphenylene sulfide (PPS), and polyetherimide (PEI).

Specifically, the synthetic resin 18 preferably contains 50% or more by volume of a high-strength polyimide resin.

High strength means that it has a tensile strength of 150 MPa or more. In the present embodiment, the synthetic resin 18 preferably contains the high-strength polyimide resin among the polyimide resin.

The high-strength polyimide resin contained in the synthetic resin 18 is preferably a highly heat-resistant polyimide resin from the viewpoint of improving dry seizing resistance.

The content of the high-strength polyimide resin in the synthetic resin 18 is preferably 50% or more by volume and 95% or less by volume, more preferably 60% or more by volume and 90% or less by volume, and especially preferably 70% or more by volume and 80% or less by volume.

The synthetic resin 18 contains the high-strength polyimide resin, whereby the fatigue resistance of the resin layer 14 is inhibited from reducing by the additives added to the synthetic resin 18.

The synthetic resin 18 preferably contains 1% or more by weight and 4% or less by weight of a silane coupling agent with respect to 100% by weight of the high-strength polyimide resin contained in the synthetic resin 18.

The synthetic resin 18 contains the silane coupling agent, whereby the bond between the synthetic resin 18 and the additives such as graphite particles 20 and a hard material 24 described below can be strengthened.

The following describes the additives to be added to the synthetic resin 18.

In the present embodiment, the synthetic resin 18 contains the graphite particles 20 and the hard material 24 as the additives.

The graphite particles 20 are dispersed in the synthetic resin 18.

The content of the graphite particles 20 in the synthetic resin 18 is 1% or more by volume and 15% or less by volume, preferably 3% or more by volume and 12% or less by volume, and more preferably 5% or more by volume and 9% or less by volume.

When the content of graphite particles 20 in the synthetic resin 18 is within the above range, the lipophilicity of the resin layer 14 can be improved and the seizing resistance in oil thereof can be improved.

The average particle diameter of the graphite particles 20 is 0.1 μm or more and 5.0 μm or less, preferably 0.5 μm or more and 4.0 μm or less, and more preferably 1.0 μm or more and 3.0 μm or less.

When the average particle diameter of the graphite particles 20 is within the above range, the total area of the surface area of the graphite particles 20 dispersed in the synthetic resin 18 increases. Thus, the seizing resistance in oil of the resin layer 14 can effectively be improved.

All the graphite particles 20 dispersed in the synthetic resin 18 are preferably scaly.

Being scaly means that their shape is a scale shape. The scaly graphite particles 20 are crystals with many AB planes (hexagonal mesh planes or basal planes) spreading in a planar shape caused by carbon atoms regularly forming a mesh structure laminated on one another and having thickness in a direction of the C-axis perpendicular to the AB planes. Since the bonding force due to van der Waals forces between the laminated AB planes is much smaller than the bonding force of the AB planes in an in-plane direction, shear is likely to occur between the AB planes. Thus, the scaly graphite particles 20 are thin in the thickness in a laminating direction against the spread of the AB planes and are thin plate shape as a whole.

The scaly graphite particles 20 function as a solid lubricant by causing shear between the AB planes when subjected to external force. Thus, all the graphite particles 20 dispersed in the synthetic resin 18 are made the scaly graphite particles 20, whereby the seizing resistance in oil of the resin layer 14 can further be improved.

The graphitization degree of the graphite particles 20 is preferably high from the viewpoint of reducing the friction coefficient. For example, the graphitization degree of the graphite particles 20 is preferably 95% or more and more preferably 99% or more.

The average particle diameter of the graphite particles 20 may be measured by the following method. Specifically, it is performed by photographing a section in a direction perpendicular to a sliding surface as the surface of the resin layer 14 of the sliding member 10 using an electron microscope at an appropriate magnification (e.g., 1,000-power), for example. Specifically, the average particle diameter of the graphite particles 20 may be obtained by measuring the areas of the graphite particles 20 included in the obtained electronic image by a general image analysis method and converting them into an average diameter when they are assumed to be circles.

The synthetic resin 18 further contains the hard material 24 as the additives. The hard material 24 preferably does not contain MoS₂. In other words, the synthetic resin 18 preferably does not contain MoS₂.

The hard material 24 contains at least one of clay, mullite, and talc. Among these, clay is preferably contained as the hard material 24 with lower hardness from the viewpoint of not impairing wear resistance. Clay is contained as the hard material 24, whereby the wear resistance of the resin layer 14 can be improved.

The content of the hard material 24 in the synthetic resin 18 is preferably 1% or more by volume and 5% or less by volume and more preferably 1% or more by volume and 3% or less by volume. When the content of the hard material 24 is within the above range, it is possible to improve the wear resistance of the resin layer 14 and to inhibit a reduction in fatigue resistance.

The average particle diameter of the hard material 24 is not limited. However, as the hard material 24, the hard material 24 having a smaller average particle diameter can improve the wear resistance of the resin layer 14 with a smaller added amount owing to an increase in the surface area thereof.

The sliding member 10 may further include a sintered layer.

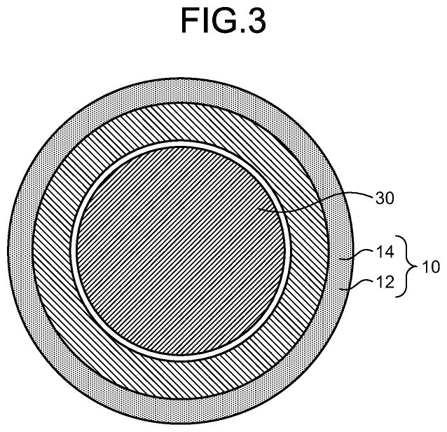

FIG. 2 is a schematic diagram of an example of a sliding member 11 including a sintered layer 26. The sliding member 11 is an example of the sliding member 10.

The sliding member 11 includes the sintered layer 26 between the base 12 and the resin layer 14. The base 12 and resin layer 14 are the same as the above.

The sintered layer 26 is a sintered body of metal powder and is a porous layer having multiple pores. The metal powder forming the sintered layer 26 may be the same metal as that of the base 12 or a different metal or material therefrom.

The sintered layer 26 is included, whereby the adhesion between the resin layer 14 and the base 12 can be improved.

(Method for Producing Sliding Member)

The sliding member 10 of the present embodiment is produced by the following processes, for example.

First, a precursor solution of the resin material 16 for a sliding member of the above configuration is applied to the base 12. Then, the layer of the precursor solution of the resin material 16 for a sliding member applied to the base 12 is dried. Through these processes, the sliding member 10 in which the resin layer 14 is laminated on the base 12 is produced. For the coating and drying conditions, known conditions may be used.

In a case in which the sintered layer 26 is provided between the base 12 and the resin layer 14, the sintered layer 26 is formed by forming a layer of metal powder on the base 12 and then sintering it. Then, the resin layer 14 may be formed by applying the precursor solution of the resin material 16 for a sliding member to the sintered layer 26, to impregnate the sintered layer 26 with the precursor solution, and then performing drying.

(Application)

The following describes an example of an application of the sliding member 10.

FIG. 3 is a schematic diagram of an example of the application of the sliding member 10. The sliding member 10 is used as bushings of fuel injection pumps, various bearings, or compressors, for example.

Specifically, a sliding device includes a shaft member 30 and the sliding member 10, for example. The shaft member 30 is a cylindrical member and functions as a shaft. The sliding member 10 is annularly shaped with the resin layer 14 placed inside and the shaft member 30 is placed thereinside, for example. That is to say, the sliding member 10 functions as a bushing.

The sliding device is not limited to the mode illustrated in FIG. 3. The shaft member 30 and the sliding member 10 may be plate shaped, for example. In place of the sliding member 10, the sliding member 11 may be used.

### EXAMPLES

The following specifically describes the present invention with reference to examples; the present invention is not limited to these examples.

Test specimens each having the resin layer 14 or a comparative resin layer described below were produced and the dry seizing resistance and the seizing resistance in oil of these specimens were evaluated.

—Production of Test Specimens—

A steel sheet (SPCC (JIS)) with a thickness of 1.5 mm was prepared as the base 12. A precursor solution containing a resin material for a sliding member or a comparative resin material for a sliding member obtained by adding the additives listed in Table 1 to the synthetic resin of the composition listed in Table 1 was prepared. This precursor solution was then applied to the base 12 by knife coating. After application, drying was performed at a temperature within a range from a room temperature to about 200° C. for 60 minutes to 90 minutes. Subsequently, the temperature was raised up to about 300° C. to perform burning for 30 minutes to 90 minutes.

Through these processes, test specimens each having the resin layer 14 for each of Example 1 to Example 8 or a comparative resin layer for each of Comparative Example 1 to Comparative Example 7 were produced.

As a high-strength PI, one having a tensile strength of 195 MPa, an elongation of 90%, an elastic modulus of 3.8 GPa, and a glass transition temperature Tg of 285° C. was used. As PI, one having a tensile strength of 119 MPa, an elongation of 47%, and a glass transition temperature Tg of 360° C. was used. As PAI, one having a tensile strength of 112 MPa, an elongation of 17%, an elastic modulus of 2.7 GPa, and a glass transition temperature Tg of 288° C. was used.

In Table 1, the content (% by weight) of the silane coupling agent indicates a content with respect to 100% by weight of the high-strength polyimide resin. As the silane coupling agent, a silane coupling agent represented by Chemical Formula 3(H₃CO)SiC₃H₆—NH—C₃H₆Si(OCH₃)₃ was used.

As the clay, one having a structural formula of Al₂O₃.2SiO₂ and an average particle diameter of 3 μm was used.

All the graphite particles of the test specimens used in Example 1 to Example 8 were scaly and had a graphitization degree of 99%.

—Evaluation—

—Dry Seizing Resistance—

For the test specimens of the examples and the comparative examples, the dry seizing resistance thereof was evaluated. The evaluation of dry seizing resistance was performed under the following conditions.

Testing machine: A friction and wear testing machine

Rotational speed: 1,450 rpm

Test temperature (temperature at the back of the bearing): Room temperature

Mating material: S45C

Lubricant: None

A test shaft was rotated under the above conditions and the time until seizure occurred on the surface of the test piece (the surface of the resin layer 14) was measured. Table 1 lists measurement results. In Table 1, a longer dry seizing time indicates higher dry seizing resistance.

—Seizing Resistance in Oil—

For the test specimens of the examples and the comparative examples, the seizing resistance in oil thereof was evaluated. The evaluation of seizing resistance in oil was performed under the following conditions.

Testing machine: A static load seizing testing machine

Rotational speed: 4,500 rpm

Test temperature (temperature at the back of the bearing): 50° C.

Mating material: S45C

Lubricant: Paraffin oil

A test shaft was rotated under the above conditions, the surface pressure of the mating material (S45C) against the surface of the resin layer 14 was increased in steps, and the maximum surface pressure at which no seizure occurred on the surface of the resin layer 14 was measured as seizing surface pressure in oil. Table 1 lists measurement results. In Table 1, higher seizing surface pressure in oil indicates higher seizing resistance in oil.

TABLE 1

| | Resin layer | | | | | | | | |
|---|---|---|---|---|---|---|---|---|---|
| | | | | Additive | | | | | |
| | Synthetic resin composition | | | Graphite particles | | Clay | | Evaluation | |
| | | | Silane | Content in | | Content in | PTFE | | Seizing |
| | | High- | coupling | synthetic | Average | synthetic | Average | Dry | surface |
| | PTFE | strength PI | agent | resin | particle | resin | particle | seizing | pressure |
| | [% by | [% by | [% by | [% by | diameter | [% by | diameter | time | in oil |
| | volume] | volume] | volume] | volume] | [μm] | volume] | [μm] | [s] | [MPa] |
| Example 1 | 5 | 82 | 3 | 10 | 1.5 | 3 | 3.5 | 69.7 | 31.0 |
| Example 2 | 5 | 89 | 3 | 5 | 1.5 | 1 | 3.5 | 68.5 | 47.9 |
| Example 3 | 10 | 77 | 3 | 10 | 1.5 | 3 | 3.5 | 81.5 | 36.4 |
| Example 4 | 15 | 72 | 3 | 10 | 1.5 | 3 | 3.5 | 93.2 | 35.2 |
| Example 5 | 15 | 77 | 3 | 5 | 1.5 | 3 | 3.5 | 109.4 | 44.9 |
| Example 6 | 20 | 67 | 3 | 10 | 1.5 | 3 | 3.5 | 111.3 | 39.9 |
| Example 7 | 25 | 62 | 3 | 10 | 1.5 | 3 | 3.5 | 147.8 | 46.2 |
| Example 8 | 25 | 79 | 3 | 5 | 1.5 | 1 | 3.5 | 127.0 | 40.6 |
| Comparative | 15 | 82 | 3 | 0 | — | 3 | 3.5 | 100.0 | 19.2 |
| Example 1 | | | | | | | | | |
| Comparative | 25 | 72 | 3 | 0 | — | 3 | 3.5 | 129.0 | 30.0 |
| Example 2 | | | | | | | | | |
| Comparative | 0 | 83 | — | 15 | 1.5 | 2 | — | 26.0 | 35.0 |
| Example 3 | | | | | | | | | |
| Comparative | — | 78 | 1 | 20 | 7 | 2 | — | — | 20.7 |
| Example 4 | | | | | | | | | |
| Comparative | — | 78 | 1 | 20 | 15 | 2 | — | — | 13.8 |
| Example 5 | | | | | | | | | |
| Comparative | — | 90 | 1 | 9 | 1.5 | 1 | — | — | 17.2 |
| Example 6 | | | | | | | | | |
| Comparative | — | 78 | 1 | 20 | 1.5 | 2 | — | — | 42.1 |
| Example 7 | | | | | | | | | |

As listed in Table 1, in the example in which the resin material 16 for a sliding member forming the resin layer 14 contains, in the synthetic resin 18, 5% or more by volume and 30% or less by volume of PTFE, 1% or more by volume and 15% or less by volume of the graphite particles 20 with an average particle diameter of 0.5 μm or more and 5.0 μm or less, and the hard material 24, it was possible to achieve both improvement in dry seizing resistance and improvement in seizing resistance in oil.

On the other hand, in the comparative example in which the comparative resin material for a sliding member forming the comparative resin layer did not have at least one of the conditions of the resin material 16 for a sliding member, at least either of dry seizing resistance and seizing resistance in oil reduced compared with that of the examples.

Thus, evaluation results have been obtained showing that when the resin layer 14 formed of the resin material 16 for a sliding member illustrated in the examples is used, both improvement in dry seizing resistance and improvement in seizing resistance in oil can be achieved compared with the comparative examples.

The various materials and their compositions used in the examples are only by way of example, and the present invention is not limited thereto. The resin material 16 for a sliding member according to the present invention may contain unavoidable impurities. The specific structure of the sliding member 10 is not limited to those exemplified in FIG. 1 and FIG. 2.

### REFERENCE SIGNS LIST

10, 11 SLIDING MEMBER

12 BASE

14 RESIN LAYER

16 RESIN MATERIAL FOR SLIDING MEMBER

18 SYNTHETIC RESIN

20 GRAPHITE PARTICLE

22 PTFE

24 HARD MATERIAL

1. A resin material for a sliding member, comprising:
a synthetic resin;
graphite particles dispersed in the synthetic resin; and
a hard material,
the synthetic resin containing 5% or more by volume and 30% or less by volume of polytetrafluoroethylene (PTFE), and a heat-resistant polyimide resin,
the graphite particles having an average particle diameter of 0.5 μm or more and 5.0 μmm or less and having a content of 1% or more by volume and 15% or less by volume in the synthetic resin.

2. The resin material for the sliding member according to claim 1, wherein the graphite particles are scaly.

3. The resin material for the sliding member according to claim 1, wherein the synthetic resin contains 50% or more by volume of the polyimide resin.

4. The resin material for the sliding member according to claim 1, wherein the synthetic resin contains 1% or more by weight and 4% or less by weight of a silane coupling agent with respect to the polyimide resin.

5. The resin material for the sliding member according to claim 1, wherein the synthetic resin contains 1% or more by volume and 5% or less by volume of a hard material.

6. The resin material for the sliding member according to claim 1, wherein the resin material does not contain MoS₂.

7. A sliding member comprising:
a base; and
a resin layer formed on the base, the resin layer being formed of the resin material for the sliding member according to claim 1.
